(19) United States
(12) Patent Application Publication
(10) Pub. No.: US 2005/0035140 A1
(43) Pub. Date: Feb. 17, 2005

(54) System and method for managing dispensation and attribution of coins

(76) Inventor: Kenneth Carter, Naples, FL (US)

Correspondence Address: SPENCER, FANE, BRITT & BROWNE, 1000 WALNUT STREET, SUITE 1400, KANSAS CITY, MO, 64106-2140, US

(21) Appl. No.: 10/867,419

(22) Filed: Jun. 14, 2004

Related U.S. Application Data
(60) Provisional application No. 60/477,581, filed on Jun. 11, 2003.

(51) Int. Cl. G07D 1/00; G07F 11/00; B07C 5/00; B65H 1/00; B65H 3/00

(52) U.S. Cl. 221/195; 453/41; 209/534; 221/197

(57) ABSTRACT

A system (10) and method for facilitating or allowing for controlling the dispensation of one or more denominations of coins via an automated coin dispensing machine (24) component of a check-out lane (12) in a retail or wholesale store setting, and for attributing the dispensed coins for accounting or reconciliation purposes. Such attribution broadly involves designating coins within the dispensing machine (24) as part of the store's safe or operating fund prior to dispensation, and as part of a cashier's till responsibility following dispensation. The coin dispensing machine (24) makes use of bulk coin hoppers (30) rather than prior art coin canisters.

### RELATED APPLICATIONS

The present U.S. non-provisional patent application claims priority benefit, with regard to all common subject, of pending U.S. provisional patent application titled “System and Method to Automatically Control and Balance Coin Change Dispensed to Customers”, Ser. No. 60/477,581, filed Jun. 11, 2003. The identified earlier-filed provisional application is hereby incorporated by reference into the present non-provisional application.

### BACKGROUND OF THE INVENTION

1. Field of the Invention

The present invention relates broadly to systems and methods for managing coins in retail and wholesale settings. More specifically, the present invention concerns a system and method for controlling the dispensation of one or more denominations of coins via an automated coin dispensing machine, and for attributing the dispensed coins for accounting or reconciliation purposes, wherein such attribution involves designating coins within the coin dispensing machine as part of a store's safe or operating fund prior to dispensation and as part of a cashier's till following dispensation.

2. Description of the Prior Art

Grocery stores and other retail and wholesale business establishments that use cash registers to facilitate sales and other business transactions must regularly stock, “construct”, or “rebuild” cash drawers, tills, or coin canisters with coins of various denominations for issuance to and use by cashiers, clerks, or other personnel or automated check-out machines, and must frequently reconcile or balance those same tills or coin canisters to ensure that the coins remaining therein accurately reflect sales or other transaction records.

Most businesses typically construct new tills by manually counting a number or value of coins of each particular denomination, and then adding the counted coins to the tills by hand. Similarly, most businesses reconcile used tills by manually removing the remaining coins of each denomination from the tills and counting the number or value of those coins by hand. Thus, it will be appreciated that constructing and reconciling tills are time and labor intensive activities that may be repeated hundreds of times each day in larger stores. Furthermore, manual counting may result in errors, and when such errors occur it is necessary to recount the coins in question. In an effort to save time, some businesses use only rolled coins when constructing tills. Unfortunately, this can substantially increase overall costs because banks or other sources typically charge between three and seven cents per roll of coins.

Prior art systems and methods are known for automating some aspects of till construction and reconciliation, but suffer from a number of problems and disadvantages, including, for example, the continued requirement that accounting personnel manually perform many of the steps involved. These prior art systems and methods therefore continue to be time and labor intensive and prone to miscounting errors. Another problem with prior art systems and methods of till construction and reconciliation is a need to repeatedly perform “pick-ups” (i.e., remove excess coins from the tills), make loans (i.e., add extra coins to the tills for change-making purposes), or make purchases of additional coins by the cashiers. As these activities typically involve several employees, the associated time and labor costs continue to be substantial.

In order to increase efficiency and cut costs, many businesses have installed automated coin dispensing machines to supplement the cashier's regular till. In use, a cash register or “point-of-sale” (POS) terminal sends electronic control signals to the coin dispensing machine, causing it to dispense an appropriate amount of change from an internal, removable, and refillable coin canister. Thus, the cashier need only accept cash and coins to his or her till and dispense cash therefrom. Unfortunately, the coins loaded into these prior art coin dispensing machines are still considered part of the cashier's till, requiring that the coin dispensing machines, or, at least, the coin canisters housed therein, be reconciled along with the cashier's till when changing cashiers. This can be a time-consuming activity and is often impractical.

In another attempt to increase efficiency and cut costs, many businesses have installed unmanned, fully-automated self-checkout systems. Typically, a single employee will monitor and be responsible for a number of these self-checkout systems and identify or address any problems that users may encounter. These self-checkout systems use automated dispensing machines for accepting and dispensing both cash and coins. It is often very difficult, however, to monitor and maintain enough coins in the coin canisters of the dispensing machines to transact business for long periods of time while accounting for and balancing the coins added during replenishment, the coins received from customers, and the coins dispensed to customers. Furthermore, while such self-checkout systems may increase efficiency and cut costs by reducing the number of cashiers, they have no effect on the time and labor costs associated with constructing and reconciling the coin canisters.

Prior art coin canisters used in prior art automated coin dispensing machines, whether supplementing a cashier's regular till or standing alone as part of a self-checkout system, do not track or communicate for tracking the number or denominations of coins dispensed. In a cashier accountability scheme, extensive management labor is required to maintain records of each coin canister's remaining coins each time a cashier signs in and out of a register or terminal. At the beginning of the cashier's shift, he or she must be provided with a full coin canister and a new till. At the end of the cashier's shift, the coins remaining in the coin canister and the coins received into the till must be counted and added together to determine a total remaining coin inventory. Any coins added to replenish the coin canister during the cashier's shift must also be considered and added to this total. This process is necessary so that an initial coin total can be compared with a final coin total to determine the cashier's responsibility. As mentioned, however, removing, transporting, and reconciling the coin canister each time the cashier takes a break, ends a shift, or otherwise leaves the lane is extremely impractical. Many establishments have therefore adopted a less labor intensive lane or terminal accountability scheme and resign themselves to decreased control and potential for increased loss. A major problem with the lane accountability scheme is that if a lane does not balance, in that fewer coins are present than should be, and more than one cashier has worked at that lane, then no one can be held accountable for the shortage.

Furthermore, prior art coin canisters require that the coins be loaded into long tubes or slots. Loading coins by hand in this manner is extremely time consuming, and inserting stacks of coins by hand into the tubes or slots within the coin canister can require a great deal of hand-eye coordination. To save time, rolled coins are often used, but, as previously mentioned, this can add substantially to the cost of operating the coin dispensing machines. Loading machines have been developed to substantially automate the initial loading process, but these machines represent additional costs, and substantial labor is still needed to prepare and position the coin canisters for filling. Furthermore, the prior art coin canisters have extremely limited capacity, and must frequently be replenished by hand because removing the coin canister from the coin dispensing machine and transporting it through the store to the automated loading machine is typically impractical if not impossible during busy times.

Due to these and other problems and disadvantages in the prior art, an improved system or method is needed for managing the dispensation of coins from automated dispensing machines and for attributing such coins for purposes of accountability and reconciliation.

### SUMMARY OF THE INVENTION

The present invention overcomes the above-described and other problems and disadvantages in the prior art by providing a system and method to facilitate or allow for controlling the dispensation of one or more denominations of coins via an automated coin dispensing machine component of a check-out lane for transacting sales, and for attributing the dispensed coins for accounting or reconciliation purposes. Such attribution broadly involves designating coins within the coin dispensing machine as part of a store's safe or operating fund prior to dispensation, and as part of a cashier's till or other responsibility following dispensation.

In a preferred embodiment, the system broadly comprises a plurality of the check-out lanes in communication with a central computing device for program execution and data storage. The check-out lanes facilitate and allow for transacting and finalizing actual sales of goods or services to purchasing customers. Each lane includes a POS terminal, a cashier's till, and the coin dispensing machine. The POS terminal receives input regarding prices of or charges for the goods or services purchased; performs any necessary or desired calculations, including, for example, summing the prices or charges, subtracting any discounts, and calculating applicable sales tax; generates a total cost payable; receives input regarding an amount tendered; and generates a total change due.

The automated coin dispensing machine substantially automatically dispenses a coin portion of the total change due in response to and under the control of the POS terminal. The coin dispensing machine includes a plurality of bulk coin hoppers; a housing including a coin slot, a lid onto which is secured or into which is incorporated a coin rail, and a check writing table; a coin-receiving cup or bowl; and a controller.

The bulk coin hoppers receive and retain a bulk amount of coins in loose, hopper fashion, and dispense a specific number of the coins in response to electronic control signals applied to the hoppers. Suitable hoppers adaptable for use in the present invention include those commonly used in the gambling and gaming industry for dispensing coins.

The controller receives electronic signals from the POS terminal regarding the total amount of coins to be dispensed; determines the particular numbers and denominations of coins to dispense in order to satisfy the total amount of coins due; communicates electronic signals to the hoppers to cause to be dispensed the determined particular numbers and denominations of coins; and communicates to the POS terminal or directly to the central computing device the particular numbers and denominations of coins dispensed so that a current balance remaining in each hopper is known and available for notification and tracking purposes.

When a cashier arrives at his or her assigned lane, the sign-in or login operation automatically causes the central computing device to record the current number and value of all coins in the coin dispensing machine. Thereafter, as coins are dispensed to purchasers, the numbers and denominations are recorded as funds added to the cashier's till responsibility. Thus, all cashiers can be easily and quickly reconciled to their exact responsibility whenever desired, even if they work at multiple lanes during a shift.

Thus, it will be appreciated that the system and method of the present invention provide a number of distinct advantages over the prior art, including, for example, providing for increased control, accountability, and security with regard to coin dispensation and reconciliation, while also providing substantial time and labor savings not possible with prior art coin canisters and coin dispensing machines. Furthermore, because the present invention uses hoppers that have substantially greater capacity than prior art coin canisters, the present invention advantageously allows for longer operation without replenishment, thereby minimizing lane interruptions. It will be appreciated that use of the hoppers also advantageously eliminates any need for and expense associated with purchasing and transporting rolled coins. Additionally, the system advantageously further improves efficiency by linking the processes of dispensation and reconciliation and treating them as necessary corollaries rather than wholly independent activities.

These and other important aspects of the present invention are more fully described in the section entitled DETAILED DESCRIPTION OF A PREFERRED EMBODIMENT, below.

### BRIEF DESCRIPTION OF THE DRAWING FIGURES

A preferred embodiment of the present invention is described in detail below with reference to the attached drawing figures, wherein:

FIG. 1 is a system diagram showing various components and relationships therebetween in a preferred embodiment of the system of the present invention;

FIG. 2 is a front elevation view of a preferred embodiment of an automated coin dispensing machine component of the system of FIG. 1, wherein the coin dispensing machine component is shown closed;

FIG. 3 is a front elevation view of the coin dispensing machine component of FIG. 2, wherein the coin dispensing machine component is shown open;

FIG. 4 is a side elevation view of the coin dispensing machine component of the system of FIG. 3; and

FIG. 5 is an isometric view of the coin dispensing machine component of the system of FIG. 3.

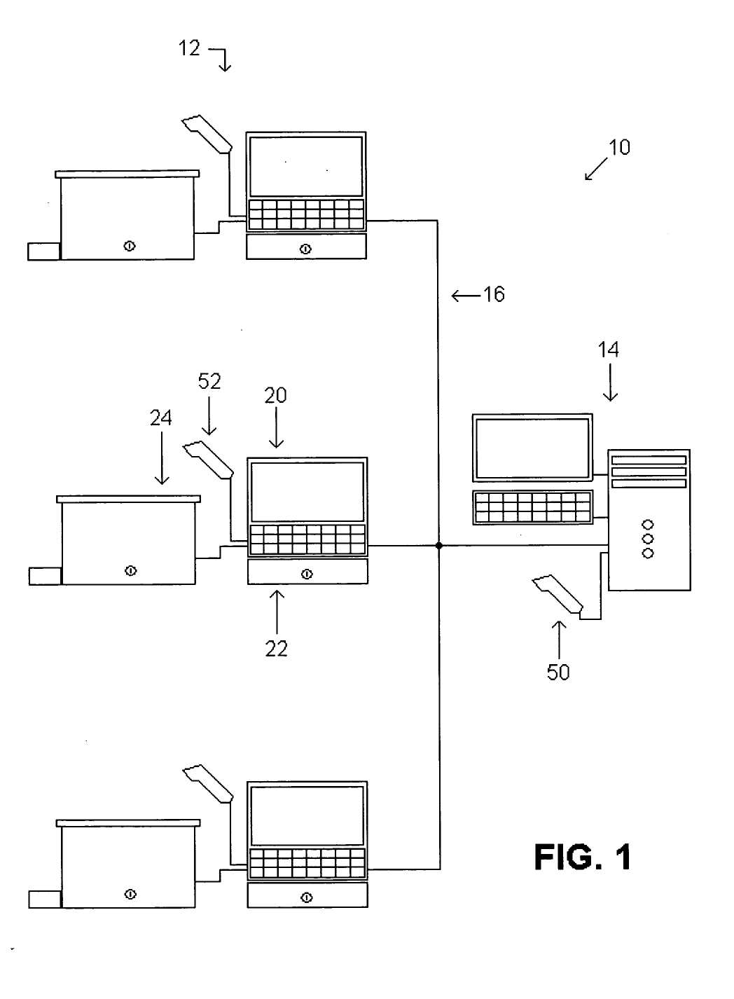

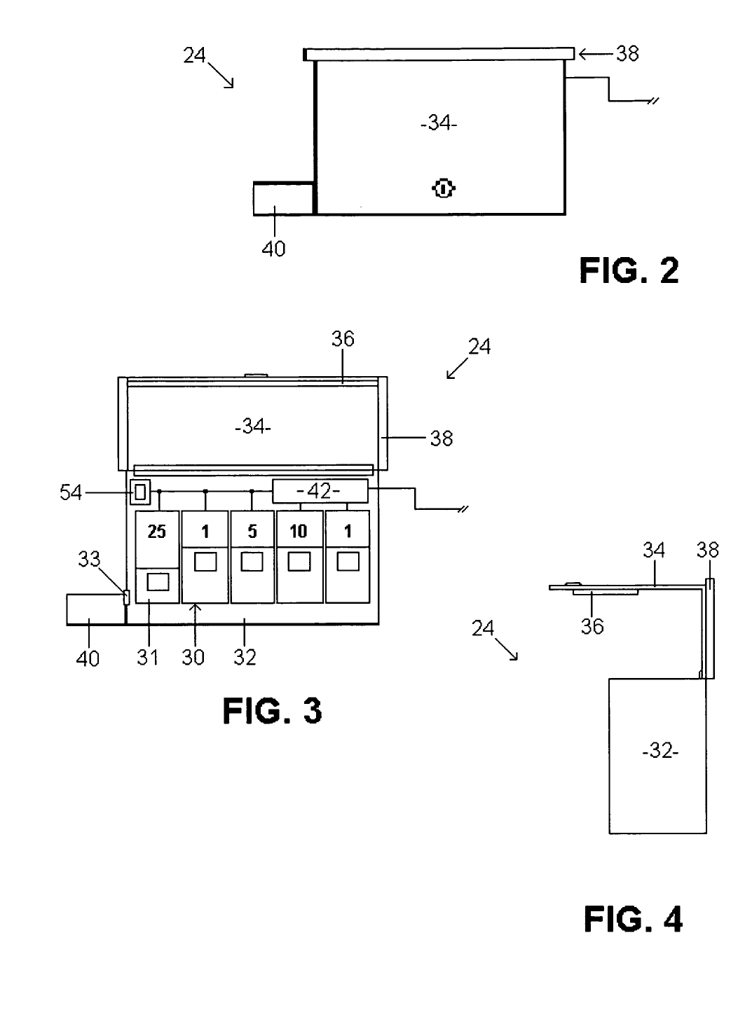

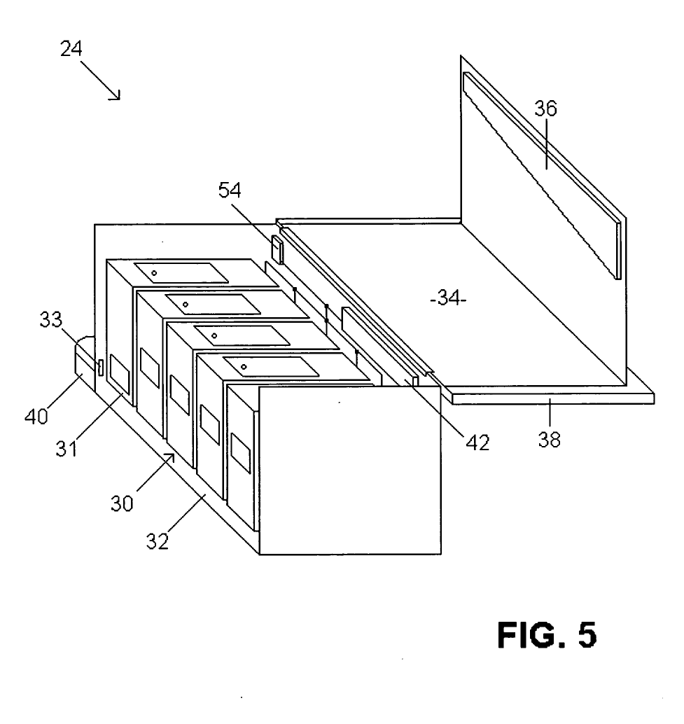

### DETAILED DESCRIPTION OF A PREFERRED EMBODIMENT

With reference to the figures, a system 10 and method for managing the dispensation and attribution of coins is disclosed, shown, and otherwise described herein in accordance with a preferred embodiment of the present invention. In one contemplated application, the system 10 and method facilitate or allow for controlling the dispensation of one or more denominations of coins via an automated coin dispensing machine component of a check-out lane for transacting sales, and for attributing the dispensed coins for accounting or reconciliation purposes. Such attribution broadly involves designating coins within the coin dispensing machine as part of a store's safe or operating fund prior to dispensation, and as part of a cashier's till or other responsibility following dispensation.

The preferred embodiment of the system 10 broadly comprises a plurality of the check-out lanes 12; a central computing device 14 for program execution and data storage; and a communication mechanism 16 allowing for communication of electronic signals between the lanes 12 and the remotely-located central computing device 14. As mentioned, it is contemplated that the present invention will be used in a retail or wholesale store setting, but it will be appreciated that the system and method may be adapted for other applications that may benefit from its advantages over the prior art.

The check-out lanes 12 facilitate and allow for transacting and finalizing actual sales of goods or services to purchasing customers. As such, each lane 12 includes a POS terminal 20, a cashier's till 22, and the automated coin dispensing machine 24. The POS terminal 20 receives input regarding prices of or charges for the goods or services purchased; performs any necessary or desired calculations, including, for example, summing the prices or charges, subtracting any discounts, and calculating applicable sales tax; generates a total cost payable; receives input regarding an amount tendered; and generates a total change due. The POS terminal 20 also communicates some or all of this information, particularly the total cost payable, amount tendered, and total change due to the central computing device 14 for processing, storage, and use in later accounting and reconciliation operations. The POS terminal 20 also initiates dispensation from the automated coin dispensing machine 24 of any coin portion (i.e., dollar fraction) of the total change due.

The cashier's till 22 receives and retains currency received from the purchaser in satisfaction of the total cost due and provides cash for dispensation to the purchaser in satisfaction of an integer dollar portion of the total change due.

The automated coin dispensing machine 24 substantially automatically dispenses a coin portion of the total change due in response to the electronic signals generated by the POS terminal 20, such that the integer dollar portion dispensed from the till 22 and the coin portion dispensed from the coin dispensing machine 24 together constitute the entire amount of the total change due. As such, the coin dispensing machine 24 includes a plurality of bulk coin hoppers 30; a housing 32 including a coin slot 33, a lid 34 onto which is secured or into which is incorporated a coin rail 36, and a check writing table 38; a coin-receiving cup or bowl 40; and a controller 42.

The bulk coin hoppers 30 receive and retain a bulk amount of coins in loose, hopper fashion (in contrast to the stacked columns of the prior art coin canisters), and dispense a specific number of the coins in response to electronic control signals applied to the hoppers 30 by the controller 42. Though four hoppers 30 are shown in the figures, one each accommodating pennies, nickels, dimes, and quarters, additional hoppers may be added, as necessary or desired, to accommodate more of the same denominations (e.g., a second hopper for quarters), additional U.S. denominations (e.g., half-dollar coins or dollar coins), or foreign denominations. Furthermore, as quarters are relatively large and frequently needed, the particular hopper 31 designated for quarters may be made larger than the other hoppers and located closest to the coin-receiving cup or bowl 40 (i.e., at the lowest point of the coin rail 36), as discussed below in additional detail. Suitable hoppers adaptable for use in the present invention include those commonly used in the gambling and gaming industry for dispensing coins.

The hoppers 30 used by the present invention have substantially greater capacity than prior art coin canisters, thereby advantageously allowing for longer operation without replenishment. Furthermore, it will be appreciated that use of the hoppers 30 advantageously eliminates any need for and expense associated with purchasing and transporting rolls of coins. It is contemplated that the hoppers 30 will be filled or replenished using sealed bags or other bulk coin containers containing known quantities of coins. Prior art machines exist for efficiently filling these bags or other containers. This facilitates periodic reconciliation of the coins within the hoppers 30. Alternatively, the hoppers 30 may be filled with unknown quantities of coins. This alternative implementation is in keeping with the notion of treating the coins contained within the hoppers 30 as part of the store's safe or operating fund until dispensed (as discussed in greater detail below). Reconciliation of the coins within all of the hoppers 30 of all of the lanes 12 is still possible as a function of an initial known total store amount of coins minus a dispensed amount, but this will not identify the amount of coins in a particular hopper or lane 12 or allow for attributing any shortage to a particular cashier.

The housing 32 receives and securely retains the hoppers 30 and the coins held therein. Though shown as being substantially rectangular in shape, the housing 32 may alternatively take any suitable shape or form and may be constructed of any suitable material, such as, for example, metal (e.g., steel or aluminum), high-impact plastic, or any of a wide variety of composite materials. The lid 34 of the housing is lockable and openable to allow for accessing, removing, replacing, and refilling the hoppers 30, as necessary or desired. The coin rail 36 directs coins dispensing from the hoppers 30 into the coin-receiving cup or bowl 40. As such, the coin rail 36 is secured to or incorporated into an interior surface of the lid 34 so as to be slanted or angled downward toward the coin slot 33, so that when the lid 34 is closed any coins dispensed by the hoppers 30 fall onto the coin rail 36 and are moved by gravity therealong to and out the coin slot 33. As mentioned, if the larger hopper 31 is used for holding quarters, realizing that it will likely dispense at a lower position than smaller hoppers, the larger hopper 31 should be located nearest the coin slot 33 where the slanted or angled coin rail 36 is lowest. The check writing table 38 provides a writing surface on which the purchaser can write checks. As shown, the check writing table 38 is secured to a top surface of the lid 34, such that when the lid 34 is closed the check-writing table 38 is horizontally oriented, but it will be appreciated that other equally suitable designs are possible.

The coin-receiving cup or bowl 40 receives and retains coins exiting the coin slot 33 for subsequent removal by the purchaser. The cup or bowl 40 is secured to the housing 32 so as to reliably remain in alignment with the coin slot 33.

The controller 42 receives the electronic signals from the POS terminal 20 regarding the total amount of coins to be dispensed; determines the particular numbers and denominations of coins to dispense in order to satisfy the total amount of coins due; communicates electronic signals to the hoppers 30 to cause to be dispensed the determined particular numbers and denominations of coins; and communicates to the POS terminal 20 or directly to the central computing device 14 the particular numbers and denominations of coins dispensed so that a current balance remaining in each hopper 30 is known and available for notification and tracking purposes. The controller 42 may be implemented in hardware, firmware, software, or any combination thereof. Alternatively, the logic for determining the particular numbers and denominations of coins to dispense may reside on the POS terminal 20, in which case the controller 42 may simply be used to direct the resulting electronic signals to the appropriate hoppers 30 or, alternatively, the controller 42 may be eliminated altogether.

Initially, the coin dispensing machine 24 at each lane 12 may be provided with pre-determined quantities of each coin denomination. The oversized hopper 31 for quarters, for example, may have a maximum capacity of 500 quarters. Replenishment bags or other coin containers will have been prepared containing 450 quarters each. When the number of coins remaining in the quarter hopper 31 reaches 50, a first notice or alert may be communicated by the controller 42, POS terminal 20, or central computing device 14. Thereafter, additional notices or alerts may be communicated periodically or continuously until the hopper 31 is replenished using the prepared bag or other coin container. The notices or alerts may be communicated using any suitable mechanism, such as, for example, visual or audible alarm mechanisms, email, electronic paging, or electronic text messaging. This feature effectively eliminates the possibility that a hopper will become completely depleted during normal operation.

The replenishment bags are preferably tamperproof sealing-type security bags provided with a bar code or other identifier. When a bag is created, the bar code or other identifier is scanned with a first scanning device 50 or otherwise entered along with a time and date stamp into the inventory of the store's safe or operating fund. This information is received by and stored on the central computing device 14. When the bag is needed to replenish a hopper 30, the bar code or other identifier is scanned by a second scanning device 52 or otherwise entered along with a time or date stamp into the particular POS terminal 20 with which the hopper 30 is associated. This information is also received by and stored on the central computing device 14. Thus, movement of the bag and the coins it contains is tracked from its creation to its use at a particular lane 12.

When a cashier arrives at his or her assigned lane 12, the sign-in or login operation will automatically cause the central computing device 14 to record the current number and value of all coins in the coin dispensing machine 24. Thereafter, as coins are dispensed to purchasers, the number and value are recorded as funds added to the cashier's till responsibility. Thus, all cashiers can be easily and quickly balanced to their exact responsibility whenever desired, even if they work at multiple lanes 12 during the shift.

In one contemplated implementation, reconciliation of the coins in the hoppers 30 is facilitated by providing an electronic or mechanical switch 54 which, when activated by an employee, causes each hopper 30 in turn to dispense any remaining coins and to count such coins as they are dispensed. The count is then displayed or otherwise communicated to the employee or transmitted directly to the POS terminal 20 or the central computing device 14. The counted and dispensed coins can then, as desired, be returned to the hopper 30.

In another contemplated implementation, reconciliation is facilitated by providing a portable scale which, when the employee removes a hopper 30 and places it on the scale, determines the total weight of each hopper 30. Alternatively, a simple, fixed scale can be provided for each hopper, possibly being incorporated into the hopper design itself. In either case, the amount of coins remaining in the hopper 30 can be determined as a function of the total weight of the hopper 30 minus the weight of the hopper 30 itself and divided by the weight of an individual coin of that particular denomination. The total weight of each hopper 30 can be displayed or otherwise communicated to the employee for manual calculation of the amount of coins, or transmitted directly to the POS terminal 20 or the central computing device 14 for automatic calculation.

The central computing device 14 receives, processes, and stores the aforementioned information regarding initial cash and coin totals (i.e., numbers and denominations) and coins subsequently dispensed from the dispensing machine 24, and automatically adjusts the initial totals appropriately in light of such subsequent dispensation by attributing the dispensed coins to the cashier's total. A suitable computer program able or readily adaptable to perform the functions required by the present invention is disclosed and described in a pending U.S. non-provisional patent application titled “Revenue Balancing Method and Computer Program”, Ser. No. 09/616,401, filed Jul. 14, 2000. Alternatively, any suitable computer program may be used, adapted, or created to perform the aforementioned functions. Programming attendant to such adaptations or creation is considered to be within the abilities of one with ordinary skill in the computer programming arts given the description set forth herein. As such, the central computing device 14 may be any conventional computing device, such as, for example, a personal desktop or portable computer or a server, having sufficient computing resources (e.g., processing speed, memory) and ability to support the computer program. The central computing device 14 may be located relatively near to or substantially remote from the other components of the system 10.

The communication mechanism 16 allows for and facilitates communication between the various system components, such as for example, between the POS terminal 20 and the central computing device 14 or between the POS terminal 20 and the controller 42. As such, the communication mechanism 16 may be any suitable mechanism or combination of mechanisms for communicating electronic signals, such as, for example, hardwired connections; wireless connections; LAN or WAN networks, such as the Internet; and infrared, RF, Bluetooth, RFID, and similar technologies.

In exemplary use and operation, the system 10 and method of the present invention function and proceed as follows. Initially, the hoppers 30 may be fully loaded with a known number of coins. This initial number is received and stored by the central computing device 14. As mentioned, when a cashier arrives at the lane 12, he or she signs-in or logs-in, which causes the device 14 to automatically associate with the particular cashier the current number and value of all coins in the coin dispensing machine 24. Thereafter, when a sale is made and coins are due in change, the POS terminal 20 sends an electronic signal to the controller 42, causing the controller 42 to determine the appropriate number and denominations of coins to dispense and to send an electronic signal to one or more of the hoppers 30 to effectuate the dispensation thereof. As the hoppers 30 release the coins, the coins fall onto the slanted or angled coin rail 36 so that the coins roll, slide, or otherwise move by gravity toward the lower end of the coin rail 36 where they exit the housing 32 via the coin slot 33 and are deposited into the coin cup 40. The number and value of the dispensed coins are sent to the central computing device 14 for recordation and added to the cashier's till responsibility.

When the coins within one of the hoppers 30 reaches fifty in number, a notice or alert is communicated to appropriate personnel. Upon receiving such a notice or alert, an employee takes one of the prepared bags of coins to the lane 12. The bar code on the bag is scanned using the scanner 54 at the lane 12, the housing 32 of the coin dispensing machine 24 is unlocked and opened, and the contents of the bag are deposited into the proper hopper 30. This addition of coins to the hopper 30 is automatically recorded by the central computing device 14.

From the preceding description, it will be appreciated that the system and method of the present invention provide a number of distinct advantages over the prior art, including, for example, providing for increased control, accountability, and security with regard to coin dispensation and reconciliation, while also providing substantial time and labor savings not possible with prior art coin canisters and automated coin dispensing machines. With regard to accountability, the system advantageously improves efficiency by linking the processes of dispensation and reconciliation and treating them as necessary corollaries rather than wholly independent activities. More specifically, dispensed coins are automatically added to the lane's or individual cashier's responsibility. This is facilitated by a seamless interface between the POS terminal or controller and the computing device. With the proper software, such as the computer program of the above-identified pending patent application, the present invention allows for continuous automatic or on-demand monitoring of the number of coins remaining in any particular hopper, and allows such monitoring of all hoppers simultaneously from a display component of the computing device. Additionally, the record of coin dispensation can, over time, allow for identifying “stale” coins with little or no turnover that could instead be deposited to earn interest.

Furthermore, because the bulk coin hoppers used by the present invention have substantially greater capacity than prior art coin canisters, the present invention advantageously allows for longer operation without replenishment, thereby minimizing lane interruptions. It will be appreciated that use of the hoppers also advantageously eliminates any need for and expense associated with purchasing and transporting rolls of coins.

Although the invention has been described with reference to the preferred embodiment illustrated in the attached drawing figures, it is noted that equivalents may be employed and substitutions made herein without departing from the scope of the invention as recited in the claims. For example, as noted above, the computer program may be implemented in hardware, firmware, software, or any combination thereof, and is not limited to the computer program disclosed and described in the identified U.S. patent. Furthermore, though described herein as involving a regular cashier's till supplemented by a coin dispensing machine, the present invention is equally applicable for use in unmanned fully-automated self-checkout systems.

1. An automated coin dispensing machine comprising:
a plurality of bulk coin hoppers, each being adapted to receive and retain an amount of coins of a particular denomination, and to dispense a specific number of the coins in response to an electronic control signal;
a controller adapted to receive as input a total value of coins to dispense, to determine an appropriate number and denomination of coins to dispense, and to generate the electronic control signals for causing one or more of the plurality of bulk coin hoppers to dispense the determined appropriate number and denomination of coins; and
a housing within which the plurality of bulk coin hoppers are located, the housing including—
a coin rail secured slantingly within the housing so as to be substantially adjacent to the plurality of bulk coin hoppers, wherein the determined appropriate number and denomination of coins dispensed by the plurality of bulk hoppers fall onto the rail, and
a coin slot aligned with a lower end of the slanting coin rail and through which the determined appropriate number and denomination of coins exit the housing.

2. The automated coin dispensing machine as set forth in claim 1, further including a check writing table secured to the housing.

3. The automated coin dispensing machine as set forth in claim 1, further including a coin-receiving cup located substantially adjacent to the coin slot and adapted to receive the determined appropriate number and denomination of coins exiting the coin slot.

4. The automated coin dispensing machine as set forth in claim 1, further including a notice mechanism adapted to communicate a notice when, for any one of the plurality of bulk coin hoppers, the amount of coins of the particular denomination reaches a predetermined number.

5. An automated coin dispensing machine comprising:
a plurality of bulk coin hoppers, each being adapted to receive and retain an amount of coins of a particular denomination, and to dispense a specific number of the coins in response to an electronic control signal;
a controller adapted to receive as input a total value of coins to dispense, to determine an appropriate number and denomination of coins to dispense, and to generate the electronic control signals for causing one or more of the plurality of bulk coin hoppers to dispense the determined appropriate number and denomination of coins;
a housing within which the plurality of bulk coin hoppers are located, the housing including—
a lid, and
a coin rail secured slantingly to an interior surface of the lid so as to be substantially adjacent to the plurality of bulk coin hoppers when the lid is closed, wherein the determined appropriate number and denomination of coins dispensed by the plurality of bulk hoppers fall onto the rail and move therealong due to gravity, and
a coin slot aligned with a lower end of the slanting coin rail and through which the determined appropriate number and denomination of coins exit the housing,
a check writing table secured to the lid housing;
a coin-receiving cup located substantially adjacent to the coin slot and adapted to receive the determined appropriate number and denomination of coins exiting the coin slot; and
a notice mechanism adapted to communicate a notice when, for any one of the plurality of bulk coin hoppers, the amount of coins of the particular denomination reaches a predetermined number.

6. A system for managing coins, the system comprising:
a point-of-sale terminal adapted to calculate a total change due and to generate an electronic signal corresponding to a coin portion of the total change due; and
an automated coin dispensing machine including—
a plurality of bulk coin hoppers, each being adapted to receive and retain an amount of coins of a particular denomination, and to dispense a specific number of the coins in response to the electronic control signal, and
a housing within which the plurality of bulk coin hoppers are located, the housing including—
a coin rail secured slantingly within the housing so as to be substantially adjacent to the plurality of bulk coin hoppers, wherein the dispensed specific number of coins dispensed by the plurality of bulk hoppers fall onto the rail and move therealong due to gravity, and
a coin slot aligned with a lower end of the slanting coin rail and through which the dispensed specific number of coins exit the housing.

7. The system as set forth in claim 6, further including a controller interposed between the point-of-sale terminal and the plurality of bulk coin hoppers and adapted to receive the electronic signal generated by the point-of-sale terminal, to determine an appropriate number and denomination of coins to dispense in order to satisfy the coin portion of the total change due, and to cause the plurality of bulk coin hoppers to dispense the determined appropriate number and denomination of coins,

8. The system as set forth in claim 6, further including a check writing table secured to the housing of the automated coin dispensing machine.

9. The system as set forth in claim 6, further including a coin-receiving cup located substantially adjacent to the coin slot and adapted to receive the specific number of coins exiting the coin slot.

10. The system as set forth in claim 6, further including a notice mechanism adapted to communicate a notice when, for any one of the plurality of bulk coin hoppers, the amount of coins of the particular denomination reaches a predetermined number.

11. A system for managing coins, the system comprising:
a point-of-sale terminal adapted to calculate a total change due and to generate a first electronic signal corresponding to a coin portion of the total change due; and
an automated coin dispensing machine including—
a controller adapted to receive the first electronic signal generated by the point-of-sale terminal, to determine an appropriate number and denomination of coins to dispense in order to satisfy the coin portion of the total change due, and to generate a second electronic control signal corresponding to the determined appropriate number and denomination of coins to dispense,
a plurality of bulk coin hoppers, each being adapted to receive and retain an amount of coins of a particular denomination, and to dispense a specific number of the coins in response to the second electronic control signal, and
a housing within which the plurality of bulk coin hoppers are located, the housing including—
a coin rail secured slantingly within the housing so as to be substantially adjacent to the plurality of bulk coin hoppers, wherein the determined appropriate number and denomination of coins dispensed by the plurality of bulk hoppers fall onto the rail and move therealong due to gravity, and
a coin slot aligned with a lower end of the slanting coin rail and through which the determined appropriate number and denomination of coins exit the housing.

12. The system as set forth in claim 11, further including a check writing table secured to the housing.

13. The system as set forth in claim 11, further including a coin-receiving cup located substantially adjacent to the coin slot and adapted to receive the determined appropriate number and denomination of coins exiting the coin slot.

14. The system as set forth in claim 11, further including a notice mechanism adapted to communicate a notice when, for any one of the plurality of bulk coin hoppers of the automated dispensing machine, the amount of coins of the particular denomination reaches a predetermined number.

15. A system for managing coins, the system comprising:
a point-of-sale terminal adapted to calculate a total change due and to generate a first electronic signal corresponding to a coin portion of the total change due; and
an automated coin dispensing machine including—
a controller adapted to receive the first electronic signal generated by the point-of-sale terminal, to determine an appropriate number and denomination of coins to dispense in order to satisfy the coin portion of the total change due, and to generate a second electronic control signal corresponding to the determined appropriate number and denomination of coins to dispense,
a plurality of bulk coin hoppers, each being adapted to receive and retain an amount of coins of a particular denomination, and to dispense a specific number of the coins in response to the second electronic control signal,
a housing within which the plurality of bulk coin hoppers are located, the housing including—
a lid,
a coin rail secured slantingly to an interior surface of the lid so as to be substantially adjacent the plurality of bulk coin hoppers when the lid is closed, wherein the determined appropriate number and denomination of coins dispensed by the plurality of bulk hoppers fall onto the rail and move therealong due to gravity,
a coin slot aligned with a lower end of the slanting coin rail and through which the determined appropriate number and denomination of coins exit the housing, and
a check writing table secured to the housing,
a coin-receiving cup located substantially adjacent to the coin slot and adapted to receive the determined appropriate number and denomination of coins exiting the coin slot, and
a notice mechanism adapted to communicate a notice when, for any one of the plurality of bulk coin hoppers of the automated dispensing machine, the amount of coins of the particular denomination reaches a predetermined number.
